(19) United States
(12) Patent Application Publication
(10) Pub. No.: US 2010/0131528 A1
(43) Pub. Date: May 27, 2010

(54) SYSTEM AND METHOD FOR IDENTIFYING ATTRIBUTES OF DIGITAL MEDIA DATA

(75) Inventor: Paul T. Mattis, Troy, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/323,523

(22) Filed: Nov. 26, 2008

(51) Int. Cl. G06F 7/06; G06F 17/30

(52) U.S. Cl. 707/758; 707/E17.143; 707/E17.016; 707/E17.102

(57) ABSTRACT

Methods and an apparatus are provided for identifying an attribute of digital media data within a digital media file. The digital media data having an associated metadata tag comprising at least one field. The apparatus comprises a storage device configured to store the digital media file and a processor coupled to the storage device. The processor is configured to detect a field within the metadata tag that is associated with an attribute category, and identify the attribute of the digital media data based on the content of the detected field.

### TECHNICAL FIELD

The present invention generally relates to digital media processing, and more particularly relates to a system and method for identifying attributes of digital media data.

### BACKGROUND OF THE INVENTION

Many digital media playback systems enable the user to provide preferences regarding the digital media data that is played or rendered. For example, a vehicle digital audio system may include a user interface that enables the user to identify one or more user preferences for the audio tracks that will be selected and played. Such user preferences may include the artist, title, genre, mood, or theme of a particular song. The vehicle digital audio system only plays audio tracks that correspond to the attributes identified by the user.

In order to identify digital media data that corresponds to attributes selected by the user, many digital media playback systems maintain a database for storing descriptive attributes associated with a large number of digital media files. This database may be provided by the publisher of the digital media data and may comprise attribute information for every file that is likely to be played or rendered. As a result, this database may be very large and may require a great deal of memory and processing resources to maintain, resulting in reduced performance of the digital media playback system. In addition, these databases must be periodically updated as additional digital media files become available. Such updates can be cumbersome and slow as they may involve a large amount of data and must be obtained from a third party (e.g., the publisher of the digital media data).

Accordingly, it is desirable to provide a system and method for detecting one or more attributes associated with a digital media file without requiring use of a large database. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

An apparatus is provided for identifying an attribute of digital media data within a digital media file. The digital media data having an associated metadata tag comprising at least one field. The apparatus comprises a storage device configured to store the digital media file and a processor coupled to the storage device. The processor is configured to detect a field within the metadata tag that is associated with an attribute category, and identify the attribute of the digital media data based on the content of the detected field.

In other embodiments, a method is provided for determining if digital media data within a digital media file corresponds to a desired attribute. The method comprises extracting a metadata tag from a header of a digital media file, the metadata tag comprising at least one field that is associated with an attribute category for describing the digital media data, detecting a field of the metadata tag that is associated with an attribute category that corresponds to the desired attribute, identifying an attribute of the digital media data based on the content of the detected field, and selecting the digital media file if the at desired attribute corresponds to the identified attribute.

### DESCRIPTION OF THE DRAWINGS

The present invention will hereinafter be described in conjunction with the following drawing figures, wherein like numerals denote like elements, and

FIG. 1 is a block diagram of an exemplary digital media file;

FIG. 2 is a block diagram of a metadata tag according to a first embodiment;

FIG. 3 is a block diagram of a metadata tag according to a second embodiment; and

FIG. 4 is a block diagram of an exemplary system for identifying attributes of digital media data.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

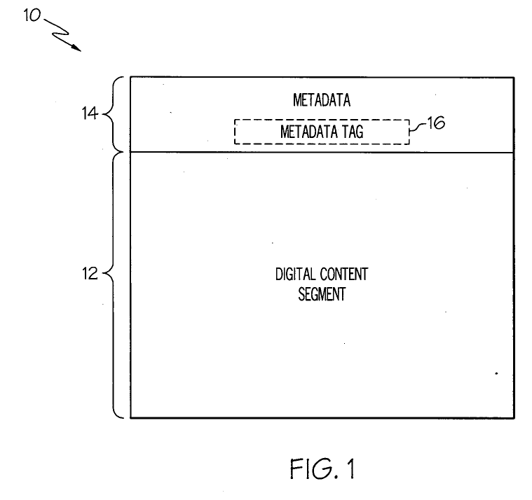

FIG. 1 is a block diagram of an exemplary digital media file 10 suitable for use with embodiments of the present invention. As depicted, digital media file 10 includes digital media data stored in a digital content segment 12. The digital media data may include digital audio data, digital video data, or any digital media data that can be played or rendered by a digital media playback device. For example, the digital media data may comprise digital audio data that enables a digital media playback device to play an audio track. It should be noted that although embodiments are described below with regard to digital audio data, alternative embodiments may also be utilized with regard to other digital media data (e.g., digital video data) that can be played or rendered by a digital media playback device.

The digital media data is associated with metadata that describes its content. In the depicted embodiment, the metadata is stored in a header 14 of the digital media file 10. However, it will be understood that in other embodiments the metadata may be in a separate location. As depicted, the metadata includes a metadata tag 16. As further described below, this metadata tag 16 describes one or more attributes associated with the digital media data.

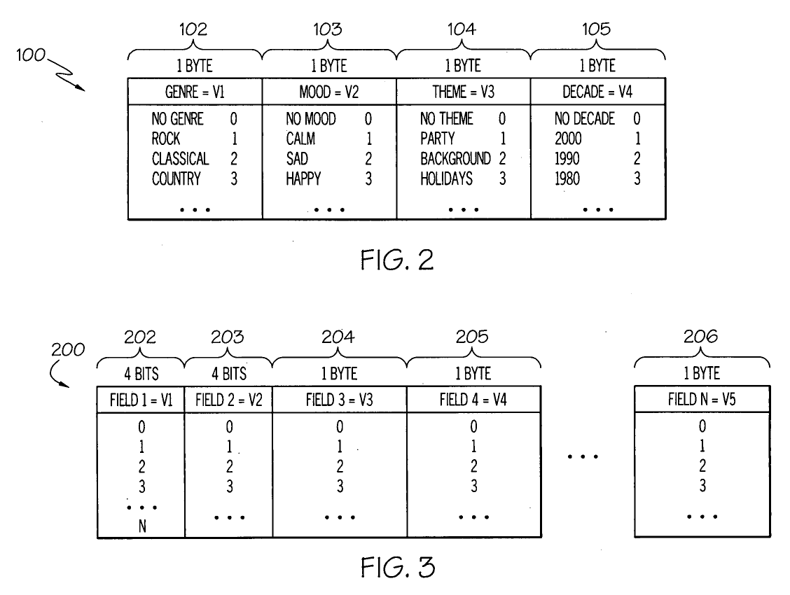

FIG. 2 is a depiction of an exemplary metadata tag 100 according to a first embodiment. Metadata tag 100 includes a plurality of fields (e.g., four as shown) 102, 103, 104, 105 each comprising, for example, an 8-bit byte. Each field 102-105 is associated with a different predetermined attribute category (e.g., genre, mood, theme, or decade) for the associated digital audio data. For example, in the depicted embodiment field 102 is associated with the genre (e.g., Rock, Classical, Country, etc.) of the digital audio data, field 103 is associated with the mood (e.g., Calm, Sad, Happy) of the digital audio data, field 104 is associated with the theme (e.g., Party, Background, Holidays) of the digital audio data, and field 105 is associated with the decade during which the digital audio data was published. Although the depicted embodiment comprises four one-byte fields 102-105 that correspond to the attribute categories genre, mood, theme, and decade respectively, it will be understood by one who is skilled in the art that alternative embodiments may utilize metadata tags having fewer or greater numbers of fields, different sized fields, or fields that correspond to different attribute categories.

The contents of fields 102-105 (e.g., V1, V2, V3, and V4, respectively) each correspond to an attribute of the digital audio data for the corresponding attribute category. For example, in the depicted embodiment V1 is a value that corresponds to a specific genre (e.g., 1=Rock, 2=Classical, 3=Country) for the associated digital audio data. Further, V2 is a value that corresponds to the actual mood (e.g., 1=Calm, 2=Sad, 3=Happy). The contents of fields 104 and 105 (e.g., V3 and V4) likewise correspond to an actual theme and decade for the associated digital audio data. As fields 102-105 in the depicted embodiment each comprise one byte, each field 102-105 may identify one of 256 possible attributes. In order to identify an attribute for the digital audio data, a processing unit must identify the field within metadata tag 100 that is associated with the attribute category and then determine the attribute based on the content of that field.

In some embodiments, the attribute categories associated with one of more of fields 102-105 for metadata tag 100 are determined based on the contents of a first field. For example, the attribute category represented by field 105 could depend on the value of V1 stored in field 102. In this case, if V1 corresponds to the genre “Hip Hop,” then the value (V4) within field 105 may correspond to the tempo (e.g., beats per minute) for the digital audio data. V4 may be the actual tempo for the digital audio data (e.g., beats per minute) or it may be a value associated with a specific tempo (e.g., 1=vivo, 2=allegro, 3=moderato) for the digital audio data. Alternatively, if V1 corresponds to the genre “Sports,” then the content of field 105 (e.g., V4) could be associated with the name of a sports team.

FIG. 3 depicts a metadata tag 200 according to a second embodiment. In this second embodiment, metadata tag 200 includes a first field 202 comprising 4 bits. The content of field 202 (e.g., V1) identifies the format of metadata tag 200. In one embodiment, V1 is a value identifying the number of additional fields (e.g., 203, 204, 205, 206) within metadata tag 200. For example, a value of V1 that is equal to four would indicate that metadata tag 200 has four fields in addition to field 202. The size of each additional field is determined beforehand. In the depicted embodiment, the first additional field 203 comprises the remaining 4 bits of the first byte of metadata tag 200 and the remaining fields 204-206 each comprise one byte. However, in other embodiment the remaining fields may have different sizes (e.g., 4 bits) that each correspond to a feature vector that is associated with a different attribute category.

Alternatively, V1 may be a value that corresponds to one of a plurality of predetermined templates for the format of metadata tag 200. Each template comprising a predetermined number of fields having a predetermined length (in bits or bytes). In this case, the processing unit parses the metadata tag in accordance with the predetermined template associated with V1.

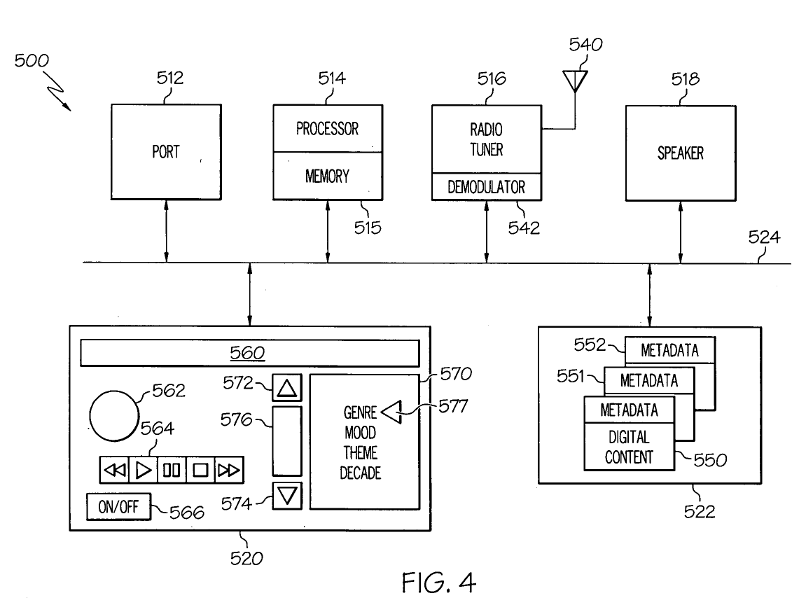

FIG. 4 is a block diagram of an exemplary system 500 for identifying attributes of digital media data. As depicted, system 500 includes a port 512, a processor 514, electronic memory 515, a radio tuner 516, at least one speaker 518, a user interface 520, and a storage device 522, each coupled to a data bus 524. Data bus 524 may be a physical interface between at least two integrated circuits, electronic control units, or similar devices. Alternatively, data bus 524 may be a logical interface within a single integrated circuit, electronic control unit, or similar device. It will be understood by one who is skilled in the art that system 500 may be utilized in connection with a plurality of digital media playback devices, including MP3 players, mobile telephones, personal digital assistants, digital media players used in vehicles, boats, or aircraft, and home-based digital media systems.

System 500 receives data, including digital audio data and associated metadata, via port 512 and/or radio tuner 516. The digital audio data and associated metadata may be in the form of the digital media file 10 of FIG. 1 (e.g., having a digital content segment 12 and a header 14 that includes the metadata tag 16 as shown in FIG. 1). However, it will be understood by one who is skilled in the art that the digital audio data and the metadata tag may be also be stored within separate files that are associated with each other.

Port 512 may comprise a Universal Serial Bus (USB) port, a FireWire (IEEE 1394) port, an Ethernet (IEEE 802.3) port, a wireless (IEEE 802.11) port, a Bluetooth® port, a card reader port, a jump drive, or any other suitable port. Port 512 receives data from one or more remote devices (e.g., personal computers, personal digital assistants (PDAs), or cell phones) and/or external memory sources (e.g., jump drives or memory cards). The data received by port 512 is provided to processor 514.

As depicted, radio tuner 516 includes an antenna 540 and a demodulator 542. Radio tuner 516 may comprise a digital frequency modulated (FM) tuner, an XM satellite radio tuner, a Sirius satellite radio tuner, High Definition (HD) radio tuner, a Digital Audio Broadcasting (DAB) tuner, or other suitable tuner. Radio tuner 516 receives data via signals (e.g., FM signals, digital signals, satellite radio signals, HD radio signals, DAB signals, and the like) via antenna 540. The signals received by radio tuner 516 are demodulated (e.g., via demodulator 542) and the corresponding data is provided to processor 514.

Storage device 522 is configured to store digital audio data and corresponding metadata tags. In one exemplary embodiment, the data storage device is a hard disk drive, or a hard drive, having at least one platter/disk (not shown) for storing the data. In the depicted embodiment, storage device 522 stores a plurality of digital media files 550, 551, and 552 of the type described above with regard to FIG. 1. Digital media files 550-552 are received via port 514 or radio tuner 516.

User interface 520 enables a user of system 500 to identify one or more desired attributes for the digital audio data that is selected and played by processor 514. As depicted, user interface 520 includes a display bar 560 for displaying information regarding the current audio track, a track selection control 562 (e.g., a rotatable knob) for selecting the current audio track, playback buttons 564 (e.g., play, pause, rewind, forward, and stop) for manipulating playback of the current audio track, and an On/Off button 566.

In addition, user interface 520 includes a playback content display 570, a scroll-up button 572, a scroll-down button 574, and a selection button 576. The user interface 520 may be used to identify one or more desired attributes via the playback content display 570. As depicted, playback content display 570 includes a list of attribute categories (e.g., genre, mood, theme, etc.) and a position indicator 577. The user browses through the attribute categories causing position indicator 577 to scroll up using the scroll-up button 572 and to scroll down using the scroll-down button 574. The user may choose one of the attribute categories using selection button 576 to reveal a plurality of corresponding attributes. For example, if the user were to choose “Genre” the playback content display 570 would display a list of genres (e.g., Rock, Country, Classical, etc.). The user may then browse and select one or more attributes for each attribute category. It should be noted that user interface 520 is only an exemplary and that other embodiments of the present invention may utilize any user interface than enables a user to select one or more desired attributes.

Processor 514 may comprise a programmable logic control system (PLC), a microprocessor, or any other type of electronic controller. It may include one or more components of a digital and/or analog type and may be programmable by software and/or firmware. Memory 515 may comprise electronic memory (e.g., ROM, RAM, or another form of electronic memory) that stores instructions and/or data in any format, including source or object code.

Processor 514 identifies attributes of digital audio data based on an associated metadata tag (e.g., the metadata tag 100 of FIG. 1). As described above, the metadata tag comprises a plurality of fields, each associated with a different attribute category (e.g., genre, mood, theme, or decade) for describing the digital audio data. The content of each field identifies a specific attribute of the digital audio data for the corresponding attribute category. Thus, processor 514 analyzes the metadata tag to detect the one or more fields that are associated with an attribute category. Processor 514 then identifies the attributes of the digital audio data based on the content of each of these detected fields.

For example, in one embodiment processor 514 extracts the metadata tag from the header 14 of a digital media file having a format substantially similar to the digital media file described with regard to FIG. 1. As described above with regard to FIG. 2, in one embodiment the metadata tag has a standardized format comprising a predetermined number of fields (e.g., four), each having a predetermined length (e.g., one byte) and corresponding to a known attribute category. In this case, processor 514 detects the fields that are associated with one or more attribute categories based on the standardized format.

However, as also described above the format of the metadata tag may vary based on values stored within one or more predetermined fields. In this case, processor 514 must analyze the values stored in these predetermined fields to detect the format of the metadata tag and the location of one or more fields that correspond to the attribute categories.

In one embodiment processor 514 identifies fields within the metadata tag that correspond to one or more desired attributes selected by the user via user interface 520. For example, if the user selected desired attributes “Classical” and “Holidays,” processor 514 would identify the fields within the metadata tag that correspond to the attribute categories of genre and theme. Processor 514 then identifies the attributes of the digital audio data that correspond to these detected categories. Finally, processor 514 determines if the identified attributes of the digital audio data correspond to the desired attributes selected by the user.

Processor 514 may analyze the metadata tag for each digital media file received at port 512 or radio tuner 516 in the manner described above. If the attributes of the digital audio data correspond to the desired attributes selected by the user via user interface 520, processor 514 plays the digital audio data via the at least one speaker 518 and/or stores the digital media file in on storage device 522. Alternatively, processor 514 may store every digital media file received via port 512 or radio tuner 516 on storage device 522. In this case, processor 514 may then analyze the metadata tag for each of these stored digital media files and generate a playlist of the digital media files that comprise digital audio data having attributes that correspond to the desired attributes. The digital audio data for each digital media file in the playlist will then be played in turn.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. An apparatus for identifying an attribute of digital media data stored within a digital media file and having an associated metadata tag comprising at least one field, the apparatus comprising:
a storage device configured to store the digital media file; and
a processor coupled to the storage device and configured to:
detect a field within the metadata tag that is associated with an attribute category; and
identify the attribute of the digital media data based on the content of the detected field.

2. The apparatus of claim 1, further comprising a user interface for enabling a user of the apparatus to identify a desired attribute and wherein the processor is further configured to:
detect the field within the metadata tag that is associated with an attribute category that corresponds to the desired attribute;
identify an attribute of the digital media data based on the content of the detected field; and
determine if the desired attribute corresponds to the identified attribute.

3. The apparatus of claim 1, wherein the digital media file comprises a digital content segment for storing the digital media data and a header that comprises the metadata tag.

4. The apparatus of claim 1, wherein the metadata tag comprises a predetermined number of fields each having a predetermined length.

5. The apparatus of claim 1, wherein the metadata tag comprises a first field for storing information regarding the format of the metadata tag.

6. The apparatus of claim 1, wherein the digital media data comprises digital audio data and the metadata tag comprises a first field that is associated with the genre of the digital audio data.

7. The apparatus of claim 1, wherein the digital media data comprises digital audio data and the metadata tag comprises a first field that is associated with the mood of the digital audio data.

8. The apparatus of claim 1, wherein the digital media data comprises digital audio data and the metadata tag comprises a first field that is associated with the theme of the digital audio data.

9. The apparatus of claim 1, wherein the metadata tag comprises four fields each having a length of one-byte and corresponding to a different attribute category.

10. The apparatus of claim 3, further comprising a radio tuner coupled to the processor and configured to receive the digital media file.

11. A method for determining if digital media data within a digital media file corresponds to a desired attribute, the method comprising:
extracting a metadata tag from a header of a digital media file, the metadata tag comprising at least one field that is associated with an attribute category for describing the digital media data;
detecting a field of the metadata tag that is associated with an attribute category that corresponds to the desired attribute;
identifying an attribute of the digital media data based on the content of the detected field; and
selecting the digital media file if the at desired attribute corresponds to the identified attribute.

12. The method of claim 11, wherein the digital media data comprises digital audio data and the step of selecting further comprises selecting the digital media file for playback to a user.

13. The method of claim 11, wherein the step of extracting further comprises extracting the metadata tag from the header of the digital media file, wherein the metadata tag comprises a predetermined number of fields each having a predetermined length.

14. The method of claim 11, wherein the step of extracting further comprises:
extracting the metadata tag from the header of the digital media file and determining the format of the metadata tag based on the value stored within a first field.

15. The method of claim 11, further comprising receiving the digital media file via a radio tuner.

16. The method of claim 11, wherein the digital media data comprises digital audio data and the step of extracting further comprises extracting the metadata tag from the header of the digital media file, wherein the metadata tag includes a first field that is associated with the genre of the digital audio data.

17. The method of claim 11, wherein the digital media data comprises digital audio data and the step of extracting further comprises extracting the metadata tag from the header of the digital media file, wherein the metadata tag includes a first field that is associated with the mood of the digital audio data.

18. A computer readable medium comprising instructions that when executed by a processor cause the processor to perform a method comprising the following steps:
receiving a desired attribute from a user;
extracting a metadata tag from a digital media file that comprises digital audio data, the metadata tag comprising a plurality of fields that are each associated with a different attribute category of the digital audio data;
detecting a field within the metadata tag that is associated with an attribute category that corresponds to the desired attribute;
identifying an attribute of the digital audio data based on the content of the detected field; and
selecting the digital media file for playback to the user if the identified attribute corresponds to the desired attribute.

19. The computer readable medium of claim 18, wherein the step of extracting further comprises extracting the metadata tag from the header of the digital media file, wherein the metadata tag comprises a predetermined number of fields each having a predetermined length.

20. The computer readable medium of claim 18, wherein the step of extracting further comprises:
extracting the metadata tag from the header of the digital media file and determining the format of the metadata tag based on the value stored within a first field.
